(19) United States
(12) Patent Application Publication
(10) Pub. No.: US 2011/0101966 A1
(43) Pub. Date: May 5, 2011

(54) MAGNETIC POSITION SENSOR COMPRISING A TAPPING LAYER CONSISTING OF AN AMORPHOUS METAL

(76) Inventors: Werner Dengler, Nueziders (AT); Gerhard Peter, Sulz (AT)

(21) Appl. No.: 12/920,537

(22) PCT Filed: Apr. 23, 2009
(86) PCT No.: PCT/EP09/02989

§ 371 Date: Dec. 8, 2010

(30) Foreign Application Priority Data
Apr. 24, 2008 (DE) 10 2008 020 690.3

(51) Int. Cl. G01B 7/14

(52) U.S. Cl. 324/207.13

(57) ABSTRACT

The invention relates to a magnetic position sensor (1) consisting of an electrically non-conductive, non-magnetic carrier (2), on which a resistive layer (3) and a tapping layer (4), which lies at a distance from and at least partially overlaps said resistive layer, are arranged. The distance is selected in such a way that under the action of a magnetic unit (5) that is moved along the regions of the resistive layer (3) and the tapping layer (4) lying above one another, said layers (3, 4) come into contact with one another. According to the invention, the tapping layer (4) is a foil consisting of an amorphous metal, upon which the force of the magnetic unit (5) acts.

The invention relates to a magnetic position sensor comprising an electrically nonconductive, nonmagnetic substrate supporting a resistive layer and a tap layer spaced from and at least partially overlapping the resistive layer, the spacing being such that, when a magnet is moved along juxtaposed regions of the resistive layer and the tap layer, the layers touch each other, according to the features of the preamble of the independent claim.

Position sensors that detect the position of an element relative to a reference position are basically known. An example of such a position sensor is disclosed in DE 43 39 931. However, this position sensor has the disadvantage that it works under pressure so that it is subjected to high wear.

To reduce this wear effect, magnetic position sensors have become known from for example DE 196 48 539 [U.S. Pat. No. 6,070,337] or DE 10 2004 004 102 [US 2007/0152658]

A generic passive magnetic position sensor is known from DE 195 26 254 [U.S. Pat. No. 5,798,640]. This position sensor consists of an electrically nonconductive and nonmagnetic substrate supporting a resistive layer and a tap layer that is spaced from and at least partially overlaps the resistive layer. The tap layer is a bending beam structure that is meander-shaped and arranged between two spacers. The spacing between the tap layer and the resistive layer is such that when a magnet, here a permanent magnet, is moved along juxtaposed regions of the resistive layer and the tap layer, the layers contact each other such that, when applying an electrical voltage to the resistive layer, a resistance change takes place that can be detected and that represents a measure for the relative position of the permanent magnet relative to the position sensor.

Such a sensor may minimize the wear effects; however, the sensor is still disadvantageous relative to its complicated structure because the tap layer in the form of a meander-shaped bending beam structure is difficult to manufacture. Moreover, it is necessary to arrange the meander-shaped bending beam structure between two spacers, giving the further disadvantage that the meander-shaped bending beam structure can be damaged during operation when subjected to mechanical load.

A generic sensor is known from DE 10 2007 055 253.1 [US 2010/0033167].

The object of the invention is therefore to provide a magnetic position sensor that works wear-free and that is further improved relative to its structure and its service life.

This object is solved, on the one hand, by the features of patent claim 1.

According to the invention the tap layer is a film of an amorphous metal upon which the force of the magnet acts. This means that the tap layer is formed at least partially, preferably completely, from the amorphous metal. In this invention, the positive properties of amorphous metals are used in an advantageous manner to react to a magnetic force on the amorphous metal film with a mechanical bending or a wave in dependence of the movement of an object that is to be detected by the magnetic position sensor. Here, all in all, the properties—purely elastic, magnetically soft, thin film, and electrically conductive—of the tap layer according to the invention are used to be able to produce a magnetic sensor with such a film of an amorphous metal in a simpler manner, to reduce the structural height, and to improve the service life. Previously it was only known that these properties of amorphous metals were used on objects independently of one another. For example, for transformer cores, only the magnetically soft properties were used, or, the purely mechanical properties of amorphous metals were used, for example, for filigree cell phone hinges. The configuration of the tap layer as a film of an amorphous metal (also called metallic glass) has the advantage that these amorphous metals are harder, more resistant to corrosion, and stronger (thus more durable), but, within certain limits, are more deformable than ordinary metals. A further advantage is that the deformations are small (approximately 1%) and the amorphous metals behave in a purely elastic manner. This means that the energy absorbed by the tap layer during movement of the object relative to the position sensor does not get lost as deformation energy but is completely released again during spring-back (thus during the further movement of the object relative to the position sensor). Another advantage is that amorphous metals are the most commonly commercially available magnetically soft materials so that the production costs of the position sensors with such a tap layer of an amorphous metal can be reduced. Furthermore, very thin films, preferably 20 μm thick (+/−25%), can be produced in an advantageous manner. In addition, the amorphous metals are electrically conductive so that with the production of the tap layer, the necessary property of electrical conductivity is obtained at the same time.

The use of a tap layer in the form of a film made of an amorphous metal, to sum it up, has the advantage that this film is considerably more robust relative to mechanical external influences on the position sensor and that such a film can be produced in a considerably simpler manner and is easier to handle during the production. Since the tap layer consists of the amorphous metal material it can be optimally attracted by the magnet, in particular a permanent magnet, at specific points in the region where the magnet acts on the resistive layer so that as a result, the desired resistance change, which is detectable, is obtained. It is thus possible that the magnet has a smaller size and also the height of the position sensor can be reduced because the smaller magnet can be moved closer to the position sensor. Moreover, with an adequate design of the substrate, the resistive layer and also the tap layer can be mounted, i.e. attached to the substrate so that the spacers required in the known prior art can be eliminated. This also results again in a reduction of the thickness of the entire position sensor.

In a particularly advantageous manner, the substrate as well as the resistive layer, the tap layer, and also a cover of the substrate are formed from a rigid or flexible film, where again the thickness of the position sensor is reduced.

In a further development of the invention, the tap layer is protected by a cover, wherein the cover is connected to the substrate of the position sensor. This allows for a simple production of the position sensor because, the substrate is produced, then is provided with the resistive layer, subsequently the tap layer is applied, and after this, the entire arrangement of the already functional position sensor is protected with an additional cover from external influences. This has the additional advantage that a position sensor of any length can be produced in this manner. If the described elements of the position sensor consist of a flexible film, it is further possible in an advantageous manner to produce in this manner, for example the basic form of the position sensor on a roll, where, depending on the desired length of position sensor to be produced, the continuous material is simply cut and processed to form a finished position sensor. The processing takes place such that fittings are provided at the ends of the cut piece of the position sensor, at one end a cable is led out of the end piece that is connected to the resistive layer and the tap layer, and at the opposite end of the cable, for example, but not necessarily, a connector is arranged. The position sensor can be coupled via this connector to an evaluation device that is configured to detect the resistance change during relative movement of the magnet and to the position sensor.

In the further development of the invention it is essential that the cover is a flux deflector plate or comprises a flux deflector plate. With such a flux deflector plate, the magnetic effect can be enhanced and the sensitivity of the position sensor or the magnetic force of the magnet can be increased and, as a result, the size of the magnet can be reduced. In this configuration it is conceivable that the cover is, for example a plastic housing in which a suitable flux deflector plate is installed and attached. The mounting can be carried out, for example, by adhesive bonding or caulking. It is also conceivable to produce the cover by injection molding, the flux deflector plate being at least partially or in particular completely enclosed by the plastic material that forms the cover. Apart from that, it is alternatively also conceivable that the cover is a rigid plastic part or a flexible plastic part, in particular a film, and the flux deflector plate is formed by an element that is an integral part and whose position is to be detected. As an example it is mentioned here that the position sensor is attached to the seat rail of a vehicle seat so that the linear movement of the seat moves the magnet relative to the position sensor that, for example, is attached to the chassis (floor) of the vehicle.

In a further development of the invention, a combination of tap layer (tap film) and resistive layer on an opposing partner film is carried out. The resistive side is structured as follows. The bas layer is a film of an amorphous metal. It may or may not be thinly coated with a dielectric. It is thinly coated with a resistance lacquer. The tap film and also the partner film with the applied resistance path form at the same time contact springs and a magnet armature. The contact actuation is effected by a magnet field that acts from outside and that is electrically generated by a permanent magnet brought into proximity or in an associated magnet coil. The magnetic field pulls the two contact tongues (wave peak and wave trough) toward each other so they tap each other at a vertex and thus close the circuit in which the resistive layer lies. As soon as the magnetic field decreases or the force falls below a certain limit (in particular if the magnet is moved perpendicularly away from the position sensor), the contact opens again due to the spring effect, i.e. the wave trough disengages from the wave peak. Since the contact tongues are attracted only near the magnet, a potentiometer circuit is formed. However, if the magnet is moved longitudinally relative to the position sensor, the wave of the tap layer and/or resistive layer rolls over the longitudinal extension of the position sensor.

The position sensor according to the invention can be applied for the following uses (without claiming completeness):
Linear and rotary 360°
Linear, also wound axially about shaft
Mounting type: Straight, waves, curves, 3D configuration Sensor is fixed and magnet is moved, or vice versa
Use preferably in vehicles in:
   Sunroof
   Seat adjustment
   Loading floor
   Sliding door
   Door
   Trunk lid
   Convertible top
   Cylinder, hydraulic and gas
   Wing, spoiler adjustment
   Window
   Gear lever, joystick
   Suspension strut
   Liquid level
   Seat back
   Steering angle
   Pedal travel and angle
   Switch fuzzy logic
Possible designs:
   Straight
   Arcuate
   Waved
   Arced
   Linear
   Rotary

In an alternative configuration of the invention it is conceivable that at least one resistive layer and/or the at least one tap layer is shaped like a finger. For an elongated position sensor, these fingers are extend transverse to the longitudinal extension and overlap at least partially so that they can contact each other under the action of the magnetic field of the magnet. This finger- or comb-like shape of the resistive layer or tap layer is present only, for example in the lateral end region (thus facing away from the region in which, for example the tap layer is clamped in the spacer), or can reach up to the region in which the respective layer is attached to the respective element, or even into it.

Another essential advantage of the position sensor according to the invention is that due to its construction and the material selection, the resistive layer and the tap layer do not stick together even if the magnet has stayed for a fairly long period at the same position. In this connection it has be explained as an example that the position sensor is attached to a seat rail of a seat of a vehicles, so the position sensor detects the position of the seat relative to the chassis of the vehicles. For this purpose, the magnet is attached to the seat. In this case it is conceivable that the seat is not moved for a long time because the vehicle is driven always by the same person. If now the seat is moved after a long time out of its initially set position, there is no risk that the deflected wave (wave trough or wave peak) of the tap layer sticks to the resistive layer. Due to the changing magnetic field as a result of the movement of the seat, the wave peak or the wave rough travels away from its original position so that the tap layer does not stick to the resistive layer despite the fact that, for the purpose of detecting the position and thus the resistance of the position sensor, they have been in contact with one another.

A further new fields of use according to the invention of the position sensor is as a potentiometer and a collector of the potentiometer is formed of an amorphous metal, or that the position sensor is configured as a reed switch and a switching contact of the reed switch is formed of an amorphous metal.

A collector formed from the amorphous metal is particularly advantageous for a contact-free and thus wear-free potentiometer, the wave of which rolls wear-free and replaces the previously used wiper. Also, the switching contacts in a reed switch are advantageously formed from the amorphous metal so that the wear-free operation is achieved also in this manner. Conceivable is also a bending beam structure with a strain gauge applied thereon. Amorphous metal films are of advantage here because they are very elastic and have a high repeatability under a bending load. In combination with a magnet (for example a magnet target), the following can be implemented:
Contactless electronic switch (thus, can replace mechanical reed switches)
Magnetic detector
Contactless position sensor
Magnetic impulse counter
Proximity switch

In comparison to normal reed switches, not only the switching positions ON and OFF can be evaluated, but also all intermediate positions.

Further configurations of the invention that result in corresponding advantages are specified in the dependent claims. Moreover, a description of the features of the dependent claims takes place hereinafter in connection with the figures.

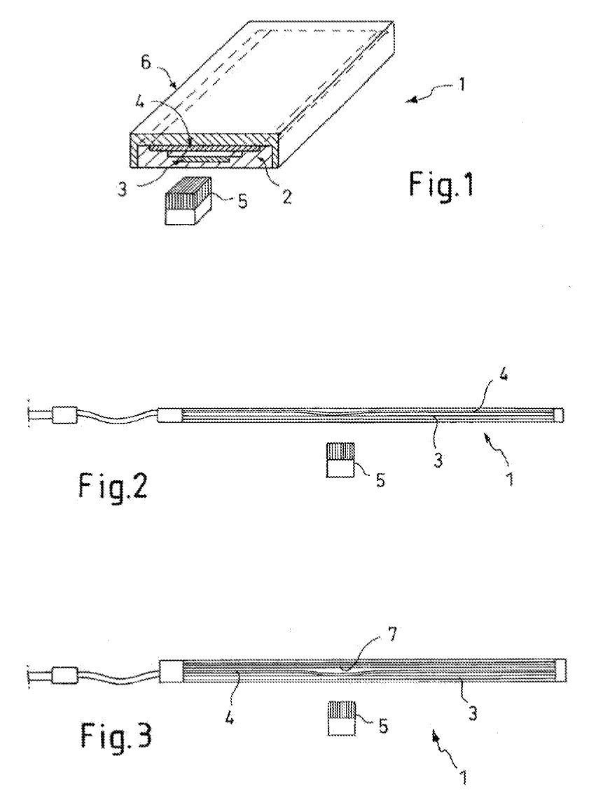

In the figures, if illustrated in detail, a magnetic position sensor is referenced 1. FIG. 1 shows that the position sensor 1 consists of an electrically nonconductive and nonmagnetic substrate 2 on which a resistive layer 3 is mounted or attached and that spaced apart therefrom and at least partially overlapping it is a tap layer 4 of an amorphous metal. The resistive layer 3 is mounted, for example, in a groove in the substrate 2, further step formations of the substrate 2 also holding the tap layer 4 in the form of the film of an amorphous metal. These two layers 3 and 4 can for example be partially or completely stamped, glued, or the like along their edges to the substrate 2. Furthermore, a magnet in the form of a permanent magnet 5 is movable relative to the position sensor 1. The previously described elements of the position sensor are protected by a cover 6 that for example also consists of an electrically nonconductive and nonmagnetic material and, for example is connected along its edges to the substrate 2. Furthermore, the upper portion of the cover 6 is a flux deflection plate to increase the magnetic effect of the magnet 5 that, in turn, results in an advantageous manner in the fact that the entire position sensor 1 can be built with a lesser thickness.

In FIGS. 2 and 3, different modes of action of the position sensor 1 are shown. It is apparent from FIG. 2 that in the region of the magnet 5, the tap layer 4 is pulled toward the resistive layer because the one pole of the magnet 5 pulls the tap layer 4 toward the resistive layer 3. Hence, the indentation shown in FIG. 2 is generated. FIG. 3 shows that the tap layer 4 is mounted on edge spacers 7 and thus is pulled parallel and only offset laterally from the spacer 7 in the region of the permanent magnet 5 onto the resistive layer 3. Thus, when the magnet 5 is moved relative to the position sensor 1 (when viewing FIGS. 2 and 3, to the right or to the left), the magnet 5 attracts the tap layer 4 in the form of the film in a wave only in the region of the permanent magnet 5 and pulls the tap layer onto the resistive layer 3 so that the respective position of the magnet 5 relative to the position sensor 1 can be detected.

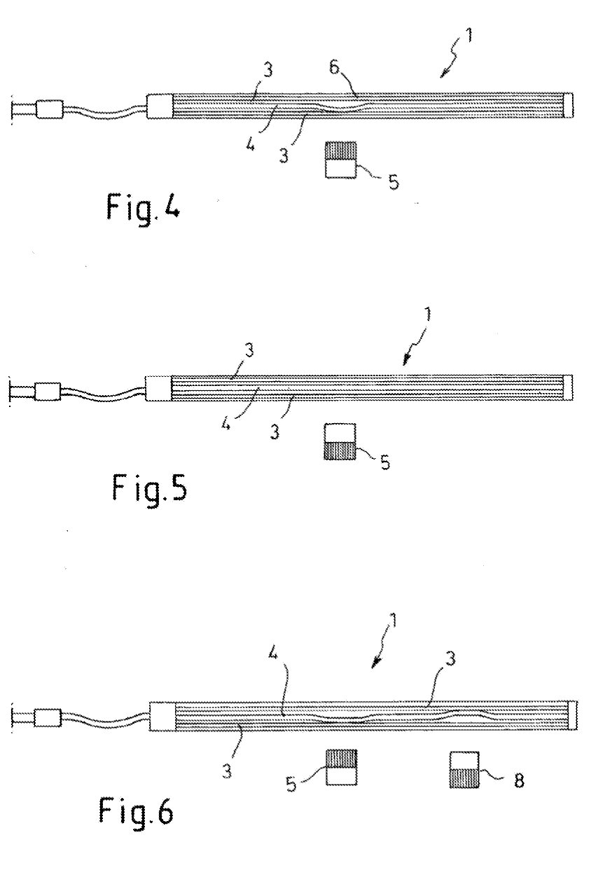

FIG. 4 shows that the position sensor 1 consists of a tap layer 4 that is magnetized onto the cover 6 that, for example, consists of a ferromagnetic material. This has the advantage that the lateral spacer 7 according to FIG. 2 can be eliminated. The permanent magnet 5 now attracts the tap layer 4 in the form of the film again in the form of a proper wave only in the region of the magnet 5 and pushes it onto the resistive layer 3.

FIG. 5 shows the same structure; however, the magnet 5 is reversed in polarity so that its magnetic field pushes the tap layer 4 in the opposite direction with the result that the tap layer 4 can be selectively pushed away from the resistive layer 3. This is of advantage, for example, when the magnet 5 with the reversed polarity is moved over the entire extension of the position sensor 1 in order to bring the tap layer 4 in a defined starting position.

FIG. 6 shows, analogously to the above-described structure of the position sensor 1, a further permanent magnet 8, the two magnets 5 and 8 being of opposite polarity and, furthermore, two resistive layers 3 with a tap layer 4 between them. Due to the reversed polarity of the two magnets 5 and 8, the tap layer 4 is pushed and pulled by the magnets in one case against the lower and in the other case against the upper resistive layer 3. Thus, the position of both magnets 5 and [8] 6 relative to the position sensor can be detected.

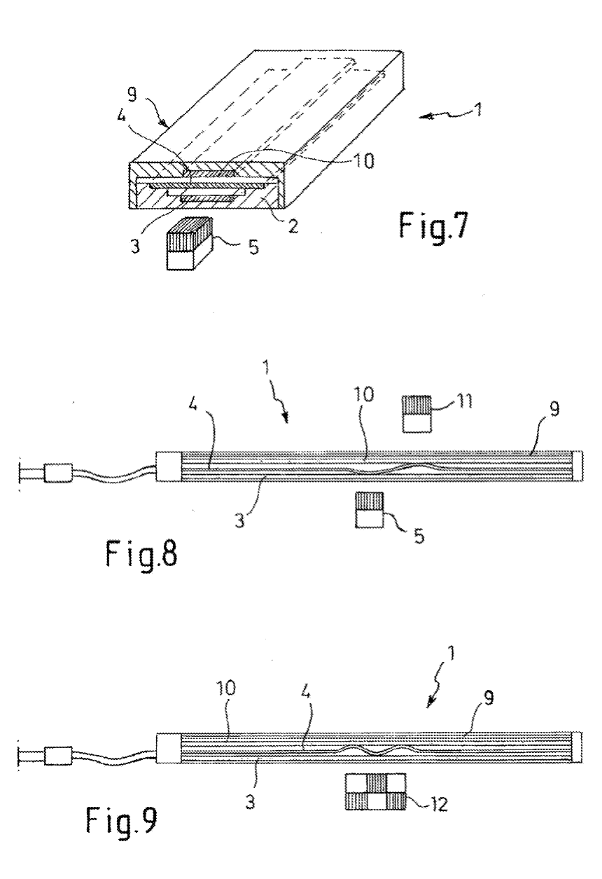

A further configuration of the position sensor 1 is illustrated in section in FIG. 7. Here two resistive layers 3 and 10 flank the tap layer 4 in the form of the film. Between the tap layer 4 in the middle and the two resistive layers 3 there is again a space so that when the permanent magnet 5 moves relative to the position sensor 1, and, depending on the polarity of the magnet 5, the tap layer 4 is either pulled to the lower resistive layer 3 or is pushed against the upper resistive layer 10. The magnet 5 is, for example, a permanent magnet or an electromagnet and can be designed as a block, bar, ring, disk or the like, and is shaped for the position sensor 1.

FIG. 8 shows, according to the structure in FIG. 7, that again two resistive layers 3 and 10 are present against which the tap layer 4 they flank can be pulled or pushed by magnets 5 and 11 arranged above and below the position sensor 1, respectively.

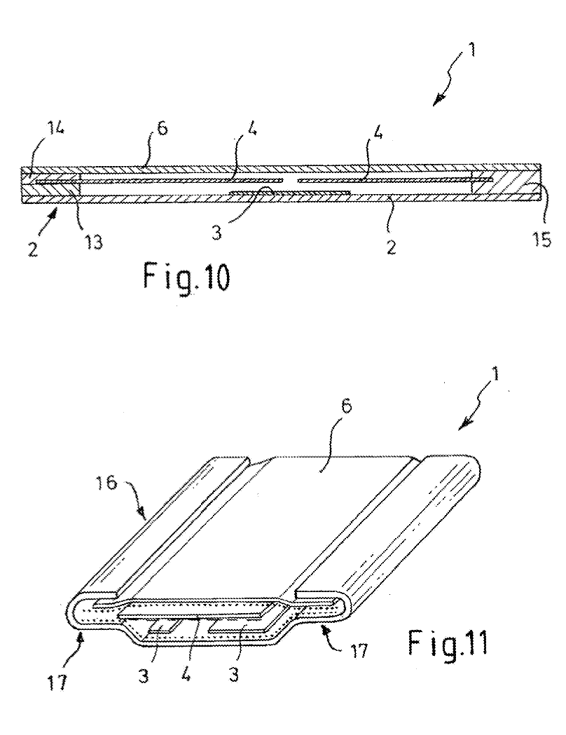

While the previous figures always show individual magnets 5, 8, and 11 that each are on one side or the same side of the position sensor, FIG. 9 shows a single magnet 12 with a pole sequence that changes within the magnet 12. As a result of the pole sequence within the one single magnet 12, the tap layer 4 is again either pulled against the lower resistive layer 3 or pushed against the upper resistive layer 4.

FIG. 10 shows a position sensor 1 in which the single tap layer 4 is flanked by two spacers 13 and 14 that are fixed by the cover 6 and the substrate, or one single spacer 15 is provided that fixes the resistive layer 4 to the substrate 2 or the cover 6. The configuration with the two spacers 13 and 14 or the single spacer 15 corresponds to the configuration shown in FIG. 3, while FIG. 10 shows the special feature that with the spacers (either 13, 14 or 15) not only one tap layer 4 is fixed to the substrate 2 or the cover 6, but that two tap layers 4 are provided that interact with the one resistive layer 3 (alternatively also with a plurality of resistive layers). This means that the flat tap layers 4 (or only one tap layer 4), that is fixed at one edge at the edge of the substrate and cover 6, floats freely in the region of the resistive layer 3 and is only pulled toward the resistive layer 3 when the magnet acts on it.

FIG. 11 shows the position sensor 1 according to one of the embodiments as shown in the FIGS. 1-10, the position sensor 1 having a protective housing 16 made of a nonmagnetic metal. This can be, for example, a metal such as aluminum, copper, brass, nickel, silver or the like. Such a protective housing 16 has the advantage that the position sensor 1 becomes much more robust, that its temperature resistance is increased, and that it can be used for purposes according to protection class IP 69. The protective housing 16 surrounds the position sensor 1 at least partially (as shown in FIG. 11) or completely, whereby according to the configuration in FIG. 11, flanges 17 are provided at the edges and enclose the edges of the substrate 2 and the cover 6. Alternatively to flanging, the side regions can also be adhered, soldered, welded together or the like.

The connection of the resistive layer 4 and the tap layer 3 (sensor film) toward the outside is carried out in a sealed manner, for example by heat sealing, conductive adhesives, a riveted crimp connection, the shown flanging, or comparable means/methods. Alternatively, the connection of the resistive layer 4 and the tap layer 3 (sensor film) to the outside can be carried out in an open manner by a conductive rubber, soldering, welding, or the like.

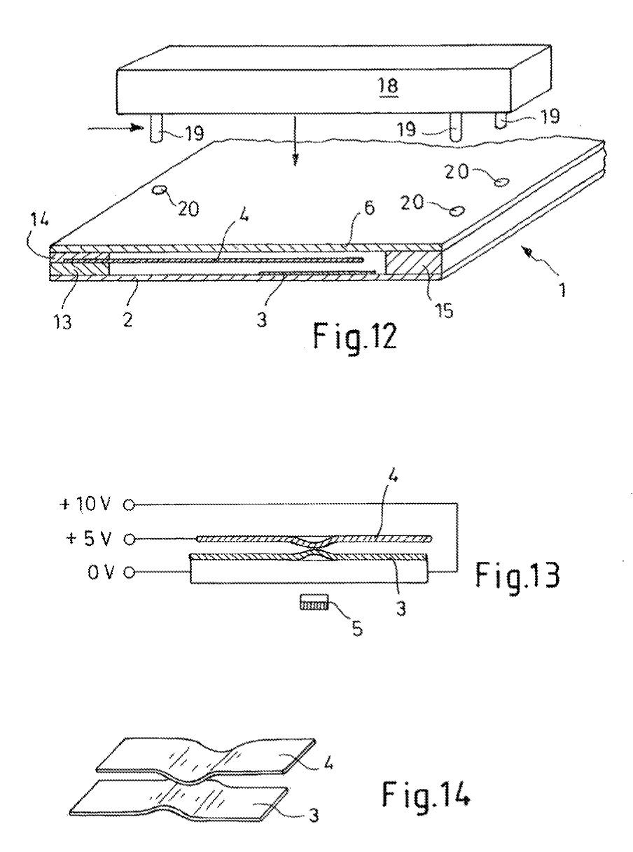

FIG. 12 shows a further configuration of the position sensor 1. Similar to the structure shown in FIG. 1, this position sensor 1 comprises the substrate 2 that is provided with the resistive layer 3. Along one edge there are spacers 13 and 14 between which the tap layer 4 is clamped. Along the opposite edge there is again the one-piece spacer 15. Above them is the cover 6. As already mentioned above, this principal structure of the position sensor 1 can be produced in any shape or any length. In case processing of the output signal of the position sensor 1 is desired, as illustrated in FIG. 12, an interface 18 can be attached in particular at the end of the position sensor 1. The interface 18 comprises a housing with a unillustrated evaluation electronic that can be connected via a cable, connecter or the like to a downstream electronic device. For contacting the electronics included in the interface 18, appropriate contacts 19, here, for example contact pins, project out of the housing, and on the edges of the position sensor 1, openings 20 are provided that can be made, for example, by stamping. The position of the openings 20 corresponds to the contact pins 19, and the openings 20 and the associated pins 19 have mechanical and/or electrical functions, depending on their position relative to the position sensor 1.

By installing an interface such as, for example, a voltage interface within the interface, the sensor data can be adapted to many different requirements of the customer's evaluation units. This way, the sensor is also protected against overload and faulty switching by the customer. Furthermore, damage to the sensor can be detected and reported to the evaluation unit.

FIGS. 13 and 14 illustrate a further configuration of the position sensor 1. Again, the one tap layer 4 and the resistive layer 3 are shown, and here the resistive layer 3 has a ferromagnetic core. This means that under action of the magnetic field of the permanent magnet 5, the resistive layer 3 as well as the tap layer 4 deform in a wave-shaped manner on movement of the permanent magnet 5. Thus, in the same manner as in the embodiments already shown and illustrated in the previous figures, a potentiometer activated by a magnetic field is formed. Since no wiping contact takes place but only a mutual abutting of the wave trough or wave peak of resistive layer or tap layer, wear can be excluded. This means that the contact in the region of abutment between the resistive layer and the tap layer is actively closed and opened, which results in the desired and detectable resistance change.

The figures always show a permanent magnet 5 whose one pole faces toward the position sensor 1 and whose opposite pole faces away therefrom. Moreover, the magnet is always arranged on one and or the other side of the position sensor 1. As an alternative to this, it is also possible for such a position sensor 1 that is elongated or otherwise shaped that the magnet encloses the position sensor 1 in a ring-segment or annular manner or in a comparable geometrical shape (for example horseshoe-shaped). It is also conceivable to arrange the poles rotated by 90° relative to the shown alignment either longitudinally or transversely of the position sensor 1. Besides an alignment of the poles of the magnet parallel or transverse to the axis of the position sensor 1, arrangements that differ therefrom (oblique alignment) are also possible; however they do not represent the preferred alignment because with an alignment of the poles of the magnet parallel or transverse to the axis of the position sensor 1, the effective forces acting on the tap layer are at their highest level.

1. A magnetic position sensor comprising an electrically nonconductive, nonmagnetic substrate supporting a resistive layer and a tap layer spaced from and at least partially overlapping the resistive layer, the spacing being such that, when a magnet is moved along juxtaposed regions of the resistive layer and the tap layer, the layers contact each other, wherein the tap layer is a film of an amorphous metal upon which the force of the magnet acts.

2. The position sensor according to claim 1, wherein the tap layer is protected by a cover, the cover being connected to the substrate.

3. The position sensor according to claim 1 wherein the cover is a flux deflection plate or comprises a flux deflection plate.

4. The position sensor according to claim 1 wherein the tap layer is arranged via a lateral spacer on the substrate and/or the cover.

5. The position sensor according to claim 1 wherein the tap layer is at least partially detached and is magnetized onto the cover and the cover consists of a ferromagnetic material.

6. The position sensor claim 1, wherein at least two tap layers are provided that interact with the resistive layer.

7. The position sensor claim 1, wherein the at least one tap layer is retained between two spacers or by one spacer at the cover and/or the substrate.

8. The position sensor claim 1, wherein the position sensor has a protective housing made of a nonmagnetic metal.

9. A position sensor, wherein the position sensor is configured as potentiometer and a collector of the potentiometer is formed of an amorphous metal.

10. A position sensor, wherein the position sensor is configured as reed switch and a switching contact of the reed switch is formed of an amorphous metal.

11. A position sensor comprising:
an elongated, electrically nonconductive, and nonmagnetic substrate;
a resistive strip extending longitudinally along the substrate;
a tap strip of a flexible film of amorphous magnetically attractable metal extending longitudinally along and spaced transversely from the resistive strip; and
a magnet movable longitudinally along the substrate adjacent and spaced transversely from the strips and polarized relative to the strips such that the magnet can attract the tap strip locally into contact with the resistive strip.

12. The position sensor defined in claim 11 wherein the tap strip is elastically flexible such that, after being locally contacted by the magnet with the resistive strip, when the magnet moves on the tap strip pulls back out of contact with the resistive strip.

13. The position sensor defined in claim 12, further comprising:
spacers holding edges of at least the tap strip such that the tap strip extends parallel to but transversely offset from the resistive strip except where attracted by the magnet.

14. The position sensor defined in claim 12, further comprising
an elongated nonmagnetic cover, the cover and substrate transversely flanking both the strips.

15. The position sensor defined in claim 11 wherein the resistive strip is fixed to the substrate.
